(19) United States
(12) Patent Application Publication
(10) Pub. No.: US 2015/0177935 A1
(43) Pub. Date: Jun. 25, 2015

(54) Digital map based 3D-character virtual interaction system for social networking

(71) Applicant: Zheng Lu, Cambridge (GB)

(72) Inventor: Zheng Lu, Cambridge (GB)

(21) Appl. No.: 14/137,905

(22) Filed: Dec. 20, 2013

(51) Int. Cl. G06F 3/0484; H04L 12/18; G01C 21/00

(52) U.S. Cl. CPC G06F 3/0484; G01C 21/005; H04L 12/1822

(57) ABSTRACT

A digital map based 3D-character geospatial virtual interaction system for social networking proposes a visual and audio presentation and virtual interaction system and methods for presenting 3D-characters which can be extended to other 3D objects (e.g. cars, buses, bikes, ships, planes, etc.) and presenting their animations and sounds for interactions on a digital map mimicking the actual persons' and/or objects' physical appearances, looks, shapes, voices, sounds, locations, movements, behaviours and interactions, some or all of which can be mimicked, the visual and audio presentation and virtual interaction system and methods being combined with a geographic information system (GIS) supported social networking platform which can store, manage and distribute geospatial and virtual interaction information along with other social networking information for use on the actual persons' computing devices (e.g., any type of computers, smartphones, tablets, microcontrollers, etc.).

### FIELD OF THE INVENTION

This invention relates to a digital map based 3D-character geospatial virtual interaction system for social networking. The present invention embodies a system that operates in the context of a digital map where the visual and audio effects for virtual interactions are presented according to relevant geospatial characteristics.

### BACKGROUND OF THE INVENTION

With the progress of hardware technologies, sensor technologies, mobile technologies, graphics and multimedia technologies and telecommunication technologies, computing devices are capable of efficiently handling a large number of interactive and interconnected tasks. The progress of graphics technologies makes it possible for current computing devices to present 3D objects efficiently. The progress of sensor technologies makes it possible to fit small sensors to most computing devices such as desktop computers, smart phones, smart glasses and watches, etc. The progress of hardware technologies significantly increases the computing power and mobility of computing devices. Further, combined with sensor technologies, telecommunication technologies and geospatial technologies, the computing devices are capable of handling multidimensional geospatial information including latitude, longitude, altitude, heading, speed, movement, acceleration, angle, direction, etc. These capabilities make powerful interactive social networking applications possible.

However, the use of conventional social networking methods does not utilize these technologies well. People communicate and socialize in a less interactive way. Conventional social networking methods mostly involve posting and transmitting text, image, video and audio information. Since these methods are not able to incorporate multidimensional information (e.g., 3D graphics, space, movements, behaviours and emotions, etc.), the applications using these methods often provide abstract, limited and non-real-time experiences. Therefore, conventional social networking methods are inadequate to create very interactive communicating and socializing experiences.

### SUMMARY OF THE INVENTION

To overcome the ineffectiveness of conventional social networking methods, the present invention proposes a visual and audio presentation and virtual interaction system and methods for presenting 3D-characters and their animations and sounds for interactions on a digital map mimicking the actual persons' physical appearances, looks, voices, sounds, locations, movements, behaviours and interactions, some or all of which can be mimicked.

The visual and audio presentation and virtual interaction system is combined with a geographic information system (GIS) supported social networking platform which can store, manage and distribute geospatial and virtual interaction information along with other conventional social networking information.

The digital map can support 2D and/or 3D mapping operations and the map can be viewed in either 2D or 3D perspective.

The system has a geospatial virtual interaction interpretation and presentation unit for translating interaction information obtained from computing devices into corresponding visual and audio effects and updates for presentation in the context of a digital map.

This system makes it possible for the individual end users to interact with each other in a way of 3D-characters and/or 3D objects based virtual interactions on the digital map.

Preferably, the system has a camera based photo to 3D-character and/or 3D object generating unit which can automatically generate 3D-characters and/or 3D objects from captured photos, other digital photos or information (e.g., gender, age, height, looks, shapes, QR codes, barcodes, etc.).

Preferably, the system has a multiple moving points routing unit which can show and dynamically update preferred routes and other routing information from one moving 3D-character and/or 3D objects to one or more other moving 3D-characters and/or 3D objects on the digital map.

### BRIEF DESCRIPTION OF THE DRAWINGS

The present invention will be described with reference to the accompanying drawings in which:

FIG. 1 shows an overview of the digital map based 3D-character geospatial virtual interaction system for social networking,

FIG. 2 shows the workflow of the camera or scanner based photo to 3D-character generating unit,

FIG. 3 shows how the multiple moving points routing unit helps present relevant routing information on the digital map.

### DETAILED DESCRIPTION OF THE INVENTION

After reading the following description it should be apparent to those skilled in the techniques how to implement the invention in various embodiments. It is understood that these embodiments are presented by way of example only, and not limitation.

A digital map based 3D-character virtual interaction system for social networking may consists of one or more of the following functional components: a digital map where 3D-characters and their visual and audio effects are presented, a geospatial virtual interaction interpretation and presentation unit, a GIS supported social networking platform, a camera based photo to 3D-character and/or 3D object generating unit and a multiple moving points routing unit.

The digital map can be implemented as part of the GIS supported social networking platform or as an independent map tiles serving platform. This platform should allow map tiles and/or other GIS information to be distributed or downloaded to the client computing devices from map servers. The digital map can support 2D and/or 3D mapping operations and the map can be viewed in either 2D or 3D perspective. The digital map can provide map tiles and other map data either online or offline. For online digital map, new map tiles and data are stored in the map databases on the servers and are dynamically downloaded to client-side computing devices. Already downloaded map tiles may be retrieved from local cache. For offline digital map, all map tiles and data are saved in the local storage and can be directly retrieved from client-side computing devices.

The geospatial virtual interaction interpretation and presentation unit can be implemented in the client-side application which can send and retrieve required virtual interaction information to and from databases on the servers. The client-side application can be installed on end user computing devices. The geospatial virtual interaction interpretation and presentation unit can translate interaction information obtained from computing devices into corresponding visual and audio effects and updates for presentation in the context of a digital map. The visual updates on the digital map can be geolocation updates of the 3D-characters indicating the actual persons' geographic location changes, or can be updates of 3D-characters indicating the actual persons' outfit changes. The visual effects on the digital map can be animations of the 3D-characters indicating the actual persons' movements and behaviours. For example, if the actual person with a sensor supported computing device like a smart phone or a smart glasses starts running, the geospatial virtual interaction interpretation and presentation unit can translate the running interaction information into an animation for the 3D-character on the digital map indicating the actual person's running movements. The audio effects can be mimics or reproductions of the voices and/or sounds of the actual persons. Combined with the visual presentation of 3D-character, this can be used for virtual voice interactions such as virtual voice chatting and virtual voice conferencing. Therefore, the geospatial virtual interaction interpretation and presentation unit can present 3D-characters and their animations and sounds on a digital map mimicking the actual persons' physical appearances, looks, voices, sounds, locations, movements, behaviours and interactions which can be detected by sensors on end user computing devices.

The 3D-characters on the digital map are the visual representations of the actual persons holding the computing devices (e.g., any type of computers and/or computing units with or without sensors, smartphones, tablets, smart glasses, smart watches, microcontrollers, etc.). The 3D-characters can be extended to other 3D objects representing the actual objects (e.g. cars, buses, bikes, ships, planes, etc.) with sensors fitted on them. The positions of the 3D-characters on the digital map indicate the actual persons' geographic location which can be determined by combination of one or more of different geolocation technologies such as global positioning system (GPS), Wi-Fi positioning system, radio frequency (RF) location methods, Internet Protocol (IP) address, MAC address, radio frequency identification (RFID), etc.

The GIS supported social networking platform can be implemented as a data and service provider on a server or interconnected servers which can support geospatial data storage, information retrieval and GIS operations. The computing devices held and/or controlled by the actual persons are interconnected via the Internet or other forms of communication networks. The interaction information from the computing devices are passed to GIS supported social networking platform which can distribute the overall interaction information along with other social networking information to the individual end users' devices which can present 3D-characters and corresponding visual and audio effects and updates on the digital map.

The camera based photo to 3D-character and/or 3D object generating unit can automatically generate 3D-characters and/or 3D objects from captured photos, other digital photos or information (e.g., gender, age, height, looks, shapes, QR codes, barcodes, etc.). The generation process can follow some approximation algorithms for pattern matching or simply use some predefined matching criteria. For approximation algorithms, 3D-character and/or 3D object is directly generated by using graphic information approximated from scanned photo image. For predefined matching criteria, if the photo's one or more graphic characteristics (e.g., shape, colour, hue, saturation, etc.) match or are close to predefined values, a corresponding predefined 3D-character and/or 3D object will be selected. The generated 3D-characters and/or 3D objects can have various appearances, looks in order to reflect the actual persons' and/or objects' physical appearances, looks, gender, shapes, emotions, etc. The photo to 3D-character and/or 3D object generating unit can be implemented in the client-side application which can send and retrieve generated 3D-character and/or 3D object information to and from databases on the servers.

The multiple moving points routing unit should be able to show and dynamically update preferred routes and other routing information from one moving 3D-character or 3D object to one or more other moving 3D-characters or 3D objects on the digital map. The routes can be visually presented on the digital map with different colours and/or patterns. For this unit, the routes and routing information can be stored in the GIS databases on the servers, and the retrieval and presentation of these routes and routing information can be implemented in the client-side application. The preferred routes between current moving 3D-character or 3D object and other moving 3D-characters or 3D objects are calculated on the GIS servers by using these moving points' geospatial information. The calculated routes information is sent back to end-user devices for presentation on the digital map.

The invention will now be described solely by way of example with reference to the accompanying drawings.

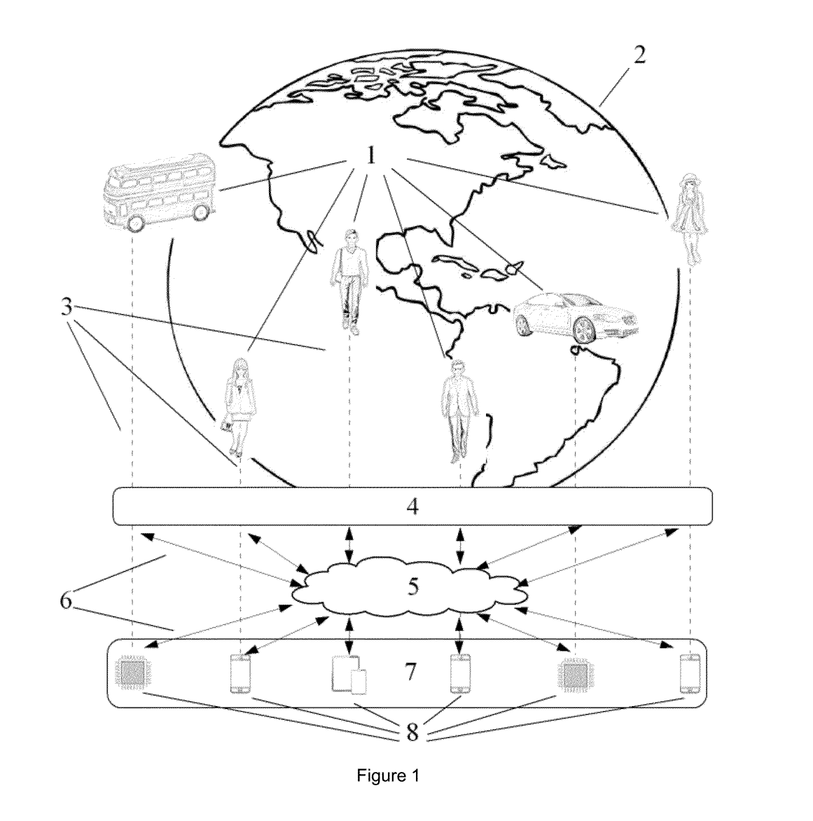

In FIG. 1, the 3D-characters and 3D objects 1 are moving and interacting with each other on the digital map 2. The dashed lines 3 represent the logic connections between the 3D-characters and computing devices. The lines with arrows represent information flows. Computing devices 8 (e.g., any type of computers and/or computing units with or without sensors, smartphones, tablets, smart glasses, smart watch, microcontrollers, etc.) logically connected to these 3D-characters and 3D objects 1 are held and/or controlled by the actual persons or fitted to the actual objects such as buses and cars. The interaction information from individual computing devices 8 is transmitted through the Internet or communication networks 5 to the GIS supported social networking platform 4 which distributes the overall interaction information and other GIS and social networking information to the individual computing devices 8 through the Internet or communication networks 5. The overall interaction information can then be translated by the geospatial virtual interaction interpretation and presentation unit 7 into corresponding visual and audio effects and updates for presentation on the digital maps of the individual computing devices 8.

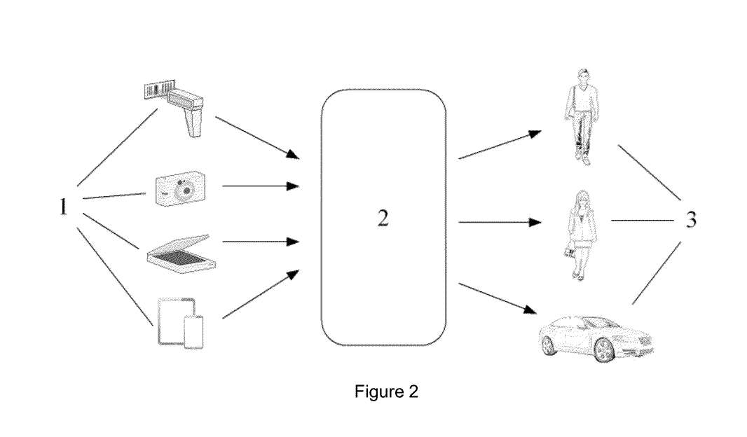

In FIG. 2, the digital photos or information captured by camera and/or various scanning devices 1 are passed to the photo to 3D-character and/or 3D object generating unit 2 as input. The photo to 3D-character and/or 3D object generating unit 2 can then automatically generate 3D-characters and/or 3D objects 3 as output according to the input information. The generated 3D-characters and/or 3D objects 3 can represent the actual persons and/or the actual objects for virtual interactions in the context of a digital map. The information of all 3D-characters and/or 3D objects representing the actual persons and/or the actual objects can be distributed by the GIS supported social networking platform to the end users' computing devices (e.g., smart phones, tablets, computers, etc.) for visual presentation.

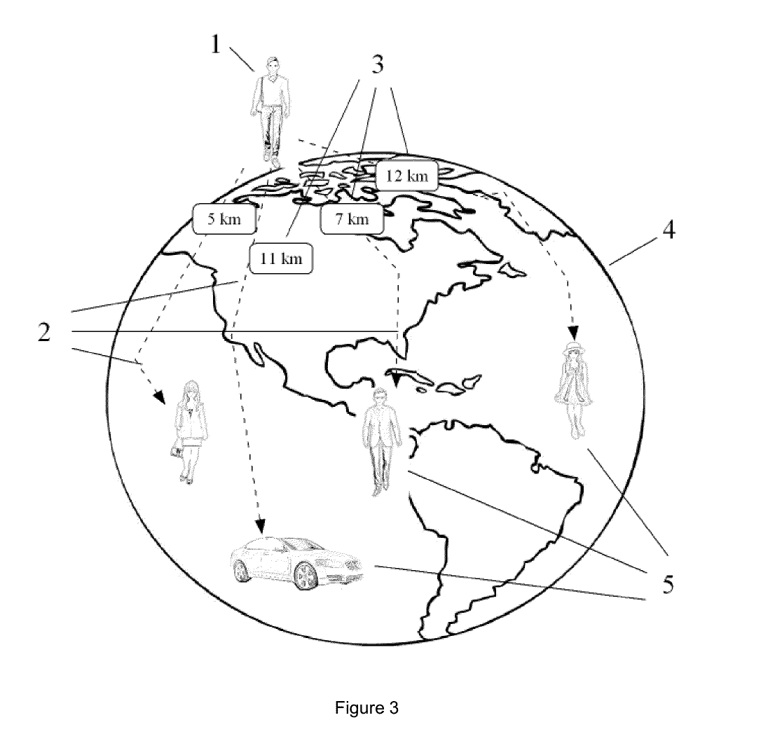

In FIG. 3, the multiple moving points routing unit can show preferred routes 2 and other routing information like distances 3 from one moving 3D-character 1 to one or more other moving 3D-characters and/or 3D objects 5 on the digital map 4. The routes and other routing information are dynamically updated when these 3D-characters and/or 3D objects are moving. All the information in FIG. 3 can be shown on end users' computing devices.

1. A digital map based 3D-character geospatial virtual interaction system for social networking proposing a visual and audio presentation and virtual interaction system and methods for presenting 3D-characters which can be extended to other 3D objects (e.g. cars, buses, bikes, ships, planes, etc.) and presenting their animations and sounds for interactions on a digital map mimicking the actual persons' and/or objects' physical appearances, looks, shapes, voices, sounds, locations, movements, behaviours and interactions, some or all of which can be mimicked, the visual and audio presentation and virtual interaction system and methods being combined with a geographic information system (GIS) supported social networking platform which can store, manage and distribute geospatial and virtual interaction information along with other social networking information for use on the actual persons' computing devices (e.g., any type of computers and/or computing units with or without sensors, smartphones, tablets, smart glasses, smart watch, microcontrollers, etc.).

2. A digital map based 3D-character geospatial virtual interaction system for social networking according to claim 1, in which the system has a geospatial virtual interaction interpretation and presentation unit for translating interaction information obtained from computing devices which are held and/or controlled by the actual persons or fitted to the actual objects into corresponding visual and audio effects and updates (e.g., geolocation updates of the 3D-characters and/or 3D objects indicating the actual persons' and/or objects' geographic location changes, animations and sounds of the 3D-characters and/or 3D objects indicating the actual persons' and/or objects' movements, behaviours and sounds, updates of 3D-characters indicating the actual persons' outfit changes, etc.) for presentation in the context of a digital map.

3. A digital map based 3D-character geospatial virtual interaction system for social networking according to claim 1, in which the system has a camera or scanner based photo to 3D-character generating unit which can automatically generate 3D-characters and/or other 3D objects for use in the context of a digital map from captured photos, other digital photos or scanned information.

4. A digital map based 3D-character geospatial virtual interaction system for social networking according to claim 1, in which the system has a multiple moving points routing unit which can show and dynamically update preferred routes and other routing information from one moving 3D-character to one or more other moving 3D-characters and/or 3D objects on the digital map.
